(19) United States
(12) Patent Application Publication
(10) Pub. No.: US 2025/0180960 A1
(43) Pub. Date: Jun. 5, 2025

(54) ELECTRONIC PAPER DISPLAY PANEL AND DISPLAY DEVICE

(71) Applicant: TCL CHINA STAR OPTOELECTRONICS TECHNOLOGY CO., LTD., Shenzhen (CN)

(72) Inventors: Caifeng WEI, Shenzhen (CN); Chunfang QIU, Shenzhen (CN); Siyu LI, Shenzhen (CN)

(73) Assignee: TCL CHINA STAR OPTOELECTRONICS TECHNOLOGY CO., LTD., Shenzhen (CN)

(21) Appl. No.: 18/964,435

(22) Filed: Nov. 30, 2024

(30) Foreign Application Priority Data
Dec. 1, 2023 (CN) 202311657914.0

(51) Int. Cl. G02F 1/16766; G02F 1/167

(52) U.S. Cl. CPC G02F 1/16766; G02F 1/167

(57) ABSTRACT

An electronic paper display panel includes multiple pixel units disposed on a substrate. Each pixel unit includes a common electrode portion, a first insulating layer, a first pixel electrode portion, a first passivation layer, and a second pixel electrode portion which are sequentially arranged in a stacked manner on the substrate. The first passivation layer includes a via, and the second pixel electrode portion is electrically connected to the first pixel electrode portion through the via. The common electrode portion and the first pixel electrode portion form a first storage capacitor, the common electrode portion and the second pixel electrode portion form a second storage capacitor, and the orthogonal projections of the common electrode portion, the first pixel electrode portion, and the second pixel electrode portion on the substrate each cover the orthogonal projection of the via on the substrate.

### CROSS-REFERENCE TO RELATED APPLICATION

This disclosure claims priority to Chinese Patent Application No. 202311657914.0, filed with the China National Intellectual Property Administration (CNIPA) on Dec. 1, 2023, the contents of which are incorporated herein by reference.

### TECHNICAL FIELD

The present disclosure relates to the field of display technology, for example, an electronic paper display panel and a display device.

### BACKGROUND

With the development of science and technology, the frequency of updating electronic digital products is higher and higher, and at the same time, a variety of new products are constantly being developed. An electronic paper display device is a new type of display device, its display effect is close to the effect of natural paper, and it can reduce visual fatigue during reading. In addition, the electronic paper display device can also realize the power-off display and have ultra-low energy consumption, making it widely used in electronic labels, electronic signage, e-readers, and other fields. The electronic paper display device has become an increasingly important flat panel display.

To meet the demand for multi-frame charging mode and long-time stable display in an electronic paper display device, the electronic paper display panel in the electronic paper display device needs to have a large storage capacitance. However, as the resolution continues to increase and the pixel size continues to decrease, the storage capacitance also decreases accordingly. Therefore, how to increase the storage capacitance as much as possible within a limited range of pixel sizes is an urgent problem to be solved by those skilled in the art.

### SUMMARY

The present disclosure provides an electronic paper display panel and a display device.

In a first aspect, the present disclosure provides an electronic paper display panel. The electronic paper display panel includes a substrate and multiple pixel units disposed on the substrate. Each of the pixel units includes a common electrode portion, a first insulating layer, a first pixel electrode portion, a first passivation layer, and a second pixel electrode portion which are sequentially arranged in a stacked manner on the substrate. The first passivation layer includes at least one via, and the second pixel electrode portion is electrically connected to the first pixel electrode portion through the at least one via. The thickness of the first insulating layer is smaller than the thickness of the first passivation layer. The common electrode portion and the first pixel electrode portion form a first storage capacitor, the common electrode portion and the second pixel electrode portion form a second storage capacitor, and the orthogonal projections of the common electrode portion, the first pixel electrode portion, and the second pixel electrode portion on the substrate each cover the orthogonal projection of the at least one via on the substrate.

In a second aspect, the present disclosure provides a display device. The display device includes a housing and an electronic paper display panel as described in any one of the foregoing. The housing has an accommodating space, the electronic paper display panel is disposed in the housing, and the display medium of the electronic paper display panel is electrophoretic particles.

### BRIEF DESCRIPTION OF THE DRAWINGS

FIG. 1 is a schematic plan view of an electronic paper display panel disclosed in some embodiments of the present disclosure.

FIG. 2 is a schematic plan view of a common electrode portion in a pixel unit disclosed in some embodiments of the present disclosure.

FIG. 3 is a schematic plan view of a first pixel electrode portion above a common electrode portion in a pixel unit disclosed in some embodiments of the present disclosure.

FIG. 4 is a schematic plan view of a first passivation layer above a first pixel electrode portion in a pixel unit disclosed in some embodiments of the present disclosure.

FIG. 5 is a schematic plan view of a second pixel electrode portion above a first passivation layer in a pixel unit disclosed in some embodiments of the present disclosure.

FIG. 6 is a cross-sectional view of a pixel unit cut along AB line shown in FIG. 5 disclosed in some embodiments of the present disclosure.

FIG. 7 is a cross-sectional view of another pixel unit cut along AB line shown in FIG. 5 disclosed in some embodiments of the present disclosure.

Reference numerals are:

Substrate 10; pixel unit 20; common electrode portion 21; first insulating layer 22; first pixel electrode portion 23; first passivation layer 24; via 241; second pixel electrode portion 25; organic protective layer 26; scan line 30; data line 40; opening zone 50; common electrode connecting portion 60; gate 70; first distance d1; second distance d2; third distance d3.

### DETAILED DESCRIPTION

In the present disclosure, unless specified to the contrary, the used orientation words such as “up” and “down” usually refer to up and down in the actual use or working state of the device, specifically the drawing directions in the drawings, and “inside” and “outside” are with respect to the contour of the device.

The following disclosure provides many different embodiments or examples used to realize the different structures of the present disclosure. To simplify the description of the present disclosure, the parts and settings of particular examples are described below. Of course, these examples are merely illustrative and are not intended to limit the present disclosure. In addition, the present disclosure may repeat reference numerals and/or reference letters in various examples, such repetition being for purposes of simplification and clarity and not in itself indicative of a relationship between the various embodiments and/or settings discussed. In addition, various specific examples of processes and materials are provided in this disclosure, but the person skilled in the art may realize the application of other processes and/or the use of other materials. The embodiments are described in detail below, and it should be noted that the order in which the following embodiments are described is not intended to be a preferred order for limiting the embodiments.

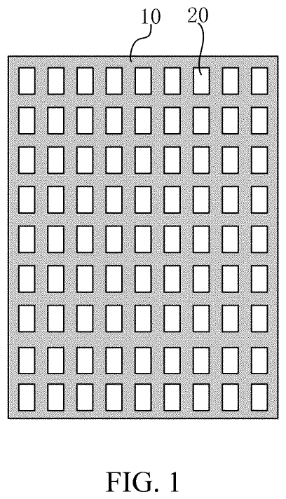

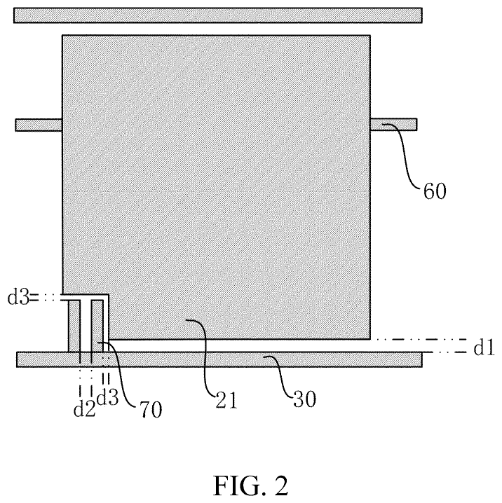

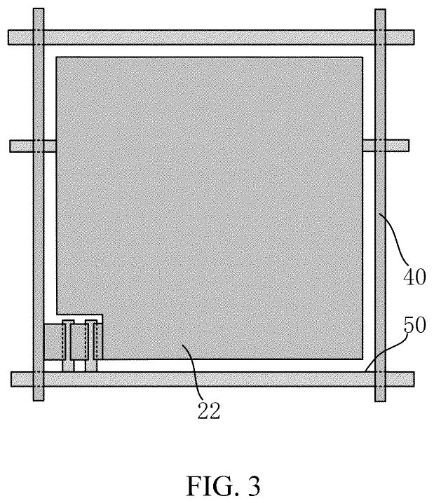

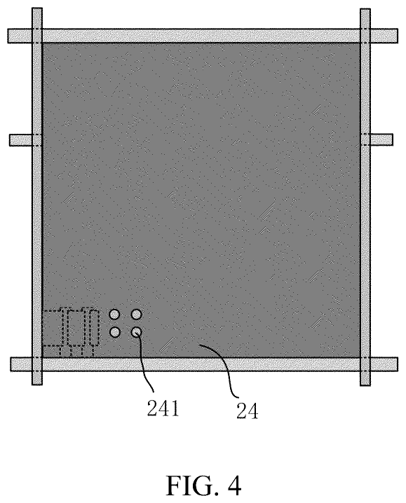

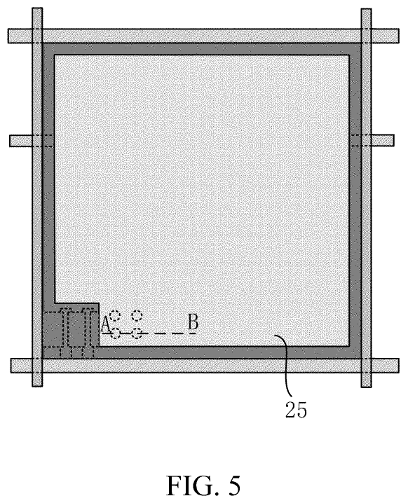

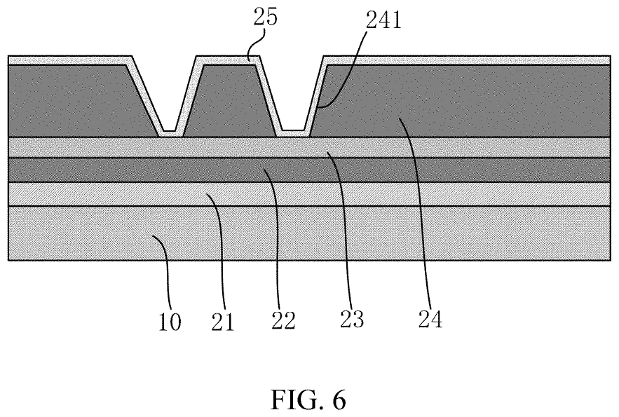

FIG. 1 is a schematic plan view of an electronic paper display panel disclosed in some embodiments of the present disclosure; FIG. 2 is a schematic plan view of a common electrode portion in a pixel unit disclosed in some embodiments of the present disclosure; FIG. 3 is a schematic plan view of a first pixel electrode portion above a common electrode portion in a pixel unit disclosed in some embodiments of the present disclosure; FIG. 4 is a schematic plan view of a first passivation layer above a first pixel electrode portion in a pixel unit disclosed in some embodiments of the present disclosure; FIG. 5 is a schematic plan view of a second pixel electrode portion above a first passivation layer in a pixel unit disclosed in some embodiments of the present disclosure; and FIG. 6 is a cross-sectional view of a pixel unit cut along AB line shown in FIG. 5 disclosed in some embodiments of the present disclosure. Referring to FIGS. 1-6, some embodiments of the present disclosure provide an electronic paper display panel. The electronic paper display panel includes a substrate 10 and multiple pixel units 20 disposed on the substrate 10, and each pixel unit 20 includes a common electrode portion 21, a first insulating layer 22, a first pixel electrode portion 23, a first passivation layer 24, and a second pixel electrode portion 25 which are sequentially arranged in a stacked manner on the substrate 10. The first passivation layer 24 includes at least one via 241, and the second pixel electrode portion 25 is electrically connected to the first pixel electrode portion 23 through the via 241. The thickness of the first insulating layer 22 is smaller than the thickness of the first passivation layer 24. The common electrode portion 21 and the first pixel electrode portion 23 form a first storage capacitor (a first storage capacitance), the common electrode portion 21 and the second pixel electrode portion 25 form a second storage capacitor (a second storage capacitance), and the orthogonal projections of the common electrode portion 21, the first pixel electrode portion 23, and the second pixel electrode portion 25 on the substrate 10 each cover the orthogonal projection of the at least one via 241 on the substrate 10.

In the electronic paper display panel provided by the embodiments of the present disclosure, since the orthogonal projections of the common electrode portion 21, the first pixel electrode portion 23, and the second pixel electrode portion 25 on the substrate 10 each cover the orthogonal projection of the at least one via 241 on the substrate 10, the common electrode portion 21, the first pixel electrode portion 23, and the second pixel electrode portion 25 all have solid structures at the location corresponding to the via 241. Thus, the via 241 does not affect the overlapping area between the common electrode portion 21 and the first pixel electrode portion 23 or the overlapping area between the common electrode portion 21 and the second pixel electrode portion 25, thereby increasing the maximum threshold value of the first storage capacitance and the second storage capacitance.

Besides, since the thickness of the first insulating layer 22 is smaller than the thickness of the first passivation layer 24, the spacing between the common electrode portion 21 and the first pixel electrode portion 23 may be set to be smaller than the spacing between the first pixel electrode portion 23 and the second pixel electrode portion 25. The smaller the spacing between two capacitor plates, the larger the capacitance. The main storage capacitor in the display panel provided by the embodiments of the present disclosure is the first storage capacitor formed by the common electrode portion 21 and the first pixel electrode portion 23. In the embodiments of the present disclosure, the maximum threshold value of the first storage capacitance can be increased by reducing the distance between the common electrode portion 21 and the first pixel electrode portion 23 (i.e., the thickness of the first insulating layer 22), which is conducive to improving the display effect of the electronic paper display panel.

In addition, reducing the distance between the common electrode portion 21 and the first pixel electrode portion 23 (i.e., the thickness of the first insulating layer 22) can also help reducing the distance between the common electrode portion 21 and the second pixel electrode portion 25, so the second storage capacitance formed by the common electrode portion 21 and the second pixel electrode portion 25 can also be increased, thereby increasing the maximum threshold value of the second storage capacitance, further improving the display effect of the electronic paper display panel.

The second pixel electrode portion 25 is electrically connected, through the via 241 in the first passivation layer 24, to the first pixel electrode portion 23 above the common electrode portion 21. Therefore, in a direction perpendicular to the substrate 10, the overlapping area between the common electrode portion 21 and the first pixel electrode portion 23 is not affected by the via 241, and the overlapping area between the common electrode portion 21 and the second pixel electrode portion 25 is not affected by the via 241, thereby allowing the overlapping area between the common electrode portion 21 and the first pixel electrode portion 23 to be increased, and allowing the overlapping area between the common electrode portion 21 and the second pixel electrode portion 25 to be increased. Thus, the maximum threshold value of the first storage capacitance and the maximum threshold value of the second storage capacitance are further increased, and the display effect of the electronic paper display panel is further improved.

In some embodiments of the present disclosure, in each pixel unit 20, the first passivation layer 24 includes multiple vias 241, and the orthogonal projections of the common electrode portion 21, the first pixel electrode portion 23, and the second pixel electrode portion 25 on the substrate 10 each cover the orthogonal projections of the multiple vias 241 on the substrate 10.

In the electronic paper display panel provided by the embodiments of the present disclosure, since the first passivation layer 24 includes the multiple vias 241, the area of electrical connection between the first pixel electrode portion 23 and the second pixel electrode portion 25 can be increased, thereby improving the conductivity between the first pixel electrode portion 23 and the second pixel electrode portion 25, which is conducive to improving the display effect of the electronic paper display panel.

Since the orthogonal projections of the common electrode portion 21, the first pixel electrode portion 23, and the second pixel electrode portion 25 on the substrate 10 each cover the orthogonal projections of the multiple vias 241 on the substrate 10, the conductivity between the first pixel electrode portion 23 and the second pixel electrode portion 25 can be improved, and at the same time, the area of any via 241 can be covered by the common electrode portion 21 and the first pixel electrode portion 23, thereby increasing the overlapping area between the common electrode portion 21 and the first pixel electrode portion 23, and increasing the overlapping area between the common electrode portion 21 and the second pixel electrode portion 25. Thus, the higher demand for the storage capacitors in the electronic paper display panel is met, and the display effect of the electronic paper display panel is improved.

In some embodiments of the present disclosure, in each pixel unit 20, connection lines connecting the multiple vias 241 enclose and form a polygonal area, and the orthogonal projections of the common electrode portion 21, the first pixel electrode portion 23, and the second pixel electrode portion 25 on the substrate 10 each cover the orthogonal projection of the polygonal area on the substrate 10.

In the electronic paper display panel provided by the embodiments of the present disclosure, the orthogonal projections of the common electrode portion 21, the first pixel electrode portion 23, and the second pixel electrode portion 25 on the substrate 10 each covers the orthogonal projection of the polygonal area on the substrate 10, thereby allowing the common electrode portion 21 and the first pixel electrode portion 23 to still form a storage capacitor structure at the position corresponding to the polygonal area, and allowing the common electrode portion 21 and the second pixel electrode portion 25 to still form a storage capacitor structure at the position corresponding to the polygonal area. Thus, the maximum threshold values of the storage capacitances are further increased, and the display effect of the electronic paper display panel is further improved.

In some embodiments of the present disclosure, the orthogonal projection of the common electrode portion 21 on the substrate 10 covers the orthogonal projection of the first pixel electrode portion 23 on the substrate 10.

In the electronic paper display panel provided by the embodiments of the present disclosure, the orthogonal projection of the common electrode portion 21 on the substrate 10 covers the orthogonal projection of the first pixel electrode portion 23 on the substrate 10, i.e., the set area of the common electrode portion 21 is not smaller than the set area of the first pixel electrode portion 23, which can avoid the problem that part of the first pixel electrode portion 23 exceeds the common electrode portion 21 and the resulted reduction in the capacitance (storage capacity) of the storage capacitor.

In some embodiments of the present disclosure, the area of the orthogonal projection of the common electrode portion 21 on the substrate 10 is equal to the area of the orthogonal projection of the first pixel electrode portion 23 on the substrate 10 and the area of the orthogonal projection of the second pixel electrode portion 25 on the substrate 10.

In the electronic paper display panel provided by the embodiments of the present disclosure, since the area of the orthogonal projection of the common electrode portion 21 on the substrate 10 is the same as the area of the orthogonal projection of the first pixel electrode portion 23 on the substrate 10 and the area of the orthogonal projection of the second pixel electrode portion 25 on the substrate 10, the overlapping area between the common electrode portion 21 and the first pixel electrode portion 23 in the electronic paper display panel can be maximized within a limited space, thereby increasing the capacitance (storage capacity) of the storage capacitor; and the overlapping area between the area of the first pixel electrode portion 23 and the area of the second pixel electrode portion 25 can be maximized, thereby increasing the effective area of the pixel unit 20, and improving the display fineness of the electronic paper display panel.

It is noted that in other embodiments of the present disclosure, the area of the orthogonal projection of the second pixel electrode portion 25 on the substrate 10 is greater than the area of the orthogonal projection of the common electrode portion 21 on the substrate 10, and the area of the orthogonal projection of the common electrode portion 21 on the substrate 10 is greater than the area of the orthogonal projection of the first pixel electrode portion 23 on the substrate 10.

Optionally, in each pixel unit 20, the edge of the common electrode portion 21 is flush with the edge of the first pixel electrode portion 23, and the edge of the first pixel electrode portion 23 is flush with the edge of the second pixel electrode portion 25.

In the electronic paper display panel provided by the embodiments of the present disclosure, the edge of the common electrode portion 21 is flush with the edge of the first pixel electrode portion 23, and the edge of the first pixel electrode portion 23 is flush with the edge of the second pixel electrode portion 25. In this manner, under the condition that the precision of the manufacturing process is satisfied, the overlapping area between the common electrode portion 21 and the first pixel electrode portion 23 can be maximized, and the overlapping area between the common electrode portion 21 and the second pixel electrode portion 25 can be maximized, thereby increasing the capacitance (storage capacity) of the storage capacitor.

In some embodiments of the present disclosure, the electronic paper display panel includes multiple scan lines 30 and multiple data lines 40, the scan lines 30 intersect the data lines 40 to form multiple opening zones 50, and the pixel units 20 are disposed within the opening zones 50, respectively. The scan lines 30 are disposed in the same layer with the common electrode portion 21, and the data lines 40 are disposed in the same layer with the first pixel electrode portion 23.

In the electronic paper display panel provided by the embodiments of the present disclosure, since the scan lines 30 are disposed in the same layer with the common electrode portion 21 and the data lines 40 are disposed in the same layer with the first pixel electrode portion 23, the common electrode portion 21 and the scan lines 30 may be formed using a single patterning process, and the first pixel electrode portion 23 and the data lines 40 may be formed using the same patterning process, thereby simplifying the process flow of the electronic paper display panel. Moreover, the data lines 40 are provided above the film layer where the scan lines 30 are located, so the common electrode portion 21 and the first pixel electrode portion 23 may be sequentially stacked on the substrate 10 by utilizing the position relationship between the data lines 40 and the scan lines 30, thereby ensuring that the common electrode portion 21 and the first pixel electrode portion 23 can form the storage capacitor structure at the position corresponding to the via 241.

In some embodiments of the present disclosure, the display panel further includes a common electrode connecting portion 60. In the extension direction of the scan lines 30, common electrode portions 21 in two adjacent pixel units 20 are electrically connected through the common electrode connecting portion 60.

Optionally, the common electrode connecting portion 60 and the common electrode portion 21 are formed integrally.

In some embodiments of the present disclosure, in each pixel unit 20, the minimum distance between the scan line 30 corresponding to the pixel unit 20 and the common electrode portion 21 in the pixel unit 20 is the first distance d1. The electronic paper display panel further includes multiple thin-film transistor groups, and the thin-film transistor groups are in one-to-one correspondence with the pixel units 20, where each of the thin-film transistor groups includes two gates 70 sequentially arranged in the extension direction of the scan lines 30, and the gates 70 are provided in the same layer with the scan lines 30. The distance between the two adjacent gates 70 is the second distance d2, and the second distance d2 is smaller than or equal to the first distance d1.

In the electronic paper display panel provided by the embodiments of the present disclosure, each thin-film transistor group includes two gates 70 sequentially arranged in the extension direction of the scan lines 30, i.e., the thin-film transistor group includes two thin-film transistors connected in series. In this manner, the leakage current of the thin-film transistor group can be reduced, the driving capability of the pixel unit 20 can be improved, and the display quality of the electronic paper display panel can be improved.

Furthermore, the first distance d1, i.e., the minimum distance between the scan line 30 and the common electrode portion 21, represents the conventional process accuracy between the block-shaped common electrode portion 21 and the line-shaped scan line 30 in the electronic paper display panel. In some embodiments of the present disclosure, the distance between two adjacent gates 70 is set to be smaller than or equal to the minimum distance between the scan line 30 and the common electrode portion 21, so that the space occupied by the thin-film transistor group can be reduced, and the area of the common electrode portion 21 and the first pixel electrode portion 23 can be further expanded. Thus, the overlapping area between the common electrode portion 21 and the first pixel electrode portion 23 is increased, and the storage capacitance is increased.

Of course, the present disclosure does not limit the number of thin-film transistors in the thin-film transistor group, and in other embodiments of the present disclosure, the thin-film transistor group may include only one thin-film transistor to further reduce the area of the thin-film transistor group.

In some embodiments of the present disclosure, the minimum distance between the edge of the gates 70 and the common electrode portion 21 is the third distance d3, and the third distance d3 is smaller than or equal to the first distance d1.

In the electronic paper display panel provided by the embodiments of the present disclosure, the first distance d1, i.e., the minimum distance between the scan line 30 and the common electrode portion 21, represents the conventional process accuracy between the block-shaped common electrode portion 21 and the line-shaped scan line 30 in the electronic paper display panel. In the embodiments of the present disclosure, the minimum distance between the edge of the gates 70 and the common electrode portion 21 is set to be smaller than or equal to the minimum distance between the scan line 30 and the common electrode portion 21, so that the space occupied by the gap between the thin-film transistor group and the common electrode portion 21 can be reduced, and the area of the common electrode portion 21 and the first pixel electrode portion 23 can be further expanded. Thus, the overlapping area between the common electrode portion 21 and the first pixel electrode portion 23 is increased, and the storage capacitance is increased.

In some embodiments of the present disclosure, the material of the common electrode portion 21 and the first pixel electrode portion 23 is an opaque metal, and the material of the second pixel electrode portion 25 is a transparent conductive material.

In some embodiments of the present disclosure, the electronic paper display panel further includes a second insulating layer and a second passivation layer provided outside the pixel units 20, the second insulating layer is provided in the same layer as the first insulating layer 22, and the second passivation layer is provided in the same layer as the first passivation layer 24.

Some embodiments of the present disclosure further provide a display device. The display device includes a housing and the electronic paper display panel as described in any one of the foregoing embodiments, the housing has an accommodating space, the electronic paper display panel is disposed in the housing, and the display medium of the electronic paper display panel is electrophoretic particles.

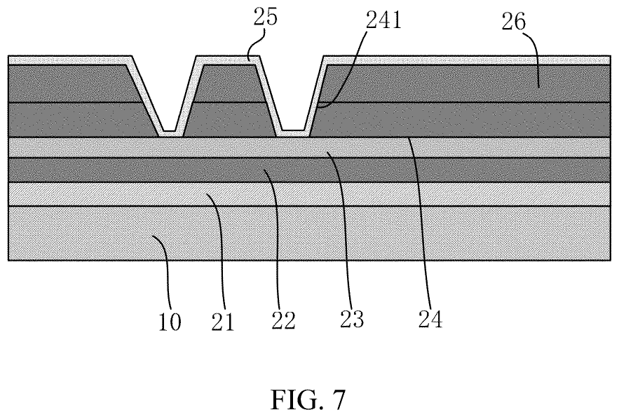

FIG. 7 is a cross-sectional view of another pixel unit cut along AB line shown in FIG. 5 disclosed in some embodiments of the present disclosure. Referring to FIGS. 1, 5, and 7, some embodiments of the present disclosure provide an electronic paper display panel, and the electronic paper display panel includes a substrate 10 and multiple pixel units 20 disposed on the substrate 10. Each pixel unit 20 includes a common electrode portion 21, a first insulating layer 22, a first pixel electrode portion 23, a first passivation layer 24, and a second pixel electrode portion 25 which are sequentially arranged in a stacked manner on the substrate 10. The first passivation layer 24 includes at least one via 241, and the second pixel electrode portion 25 is electrically connected to the first pixel electrode portion 23 through the via 241. The thickness of the first insulating layer 22 is smaller than the thickness of the first passivation layer 24. The common electrode portion 21 and the first pixel electrode portion 23 form a first storage capacitor, the common electrode portion 21 and the second pixel electrode portion 25 form a second storage capacitor, and the orthogonal projections of the common electrode portion 21, the first pixel electrode portion 23, and the second pixel electrode portion 25 on the substrate 10 each cover the orthogonal projection of the at least one via 241 on the substrate 10.

It should be noted that the structure of the electronic paper display panel provided in these embodiments of the present disclosure is similar to the structure of the electronic paper display panel provided in the above embodiments of the present disclosure, and these embodiments of the present disclosure are described without repeating the same parts.

The difference is that each pixel unit 20 further includes an organic protective layer 26, and the organic protective layer 26 is disposed between the first passivation layer 24 and the second pixel electrode portion 25. The organic protective layer 26 can provide a planarization for the second pixel electrode portion 25, which is conducive to improving the film-forming quality of the second pixel electrode portion 25, and improving the display effect of the electronic paper display panel.

Some embodiments of the present disclosure further provide a display device. The display device includes a housing and an electronic paper display panel as described in any one of the foregoing embodiments, the housing has an accommodating space, the electronic paper display panel is disposed in the housing, and the display medium of the electronic paper display panel is electrophoretic particles.

In summary, the embodiments of the present disclosure provide an electronic paper display panel and a display device, where the electronic paper display panel includes a substrate and multiple pixel units disposed on the substrate. Each pixel unit includes a common electrode portion, a first insulating layer, a first pixel electrode portion, a first passivation layer, and a second pixel electrode portion which are sequentially arranged in a stacked manner on the substrate. The first passivation layer includes at least one via, and the second pixel electrode portion is electrically connected to the first pixel electrode portion through the via. The thickness of the first insulating layer is smaller than the thickness of the first passivation layer. The common electrode portion and the first pixel electrode portion form a first storage capacitor, the common electrode portion and the second pixel electrode portion form a second storage capacitor, and the orthogonal projections of the common electrode portion, the first pixel electrode portion, and the second pixel electrode portion on the substrate each cover the orthogonal projection of the at least one via on the substrate. The storage capacitors in the display panel and the display device provided in the embodiments of the present disclosure have a higher capacitance (storage capacity), which is conducive to improving the display effect of the electronic paper display panel.

The embodiments of the present disclosure provide the electronic paper display panel and the display device, which can increase the storage capacitance as much as possible within a limited range of pixel sizes, thereby meeting the needs of multi-frame charging mode and long-time stable display of the electronic paper display panel.

What is claimed is:

1. An electronic paper display panel, comprising:
a substrate and a plurality of pixel units disposed on the substrate;
wherein each of the plurality of pixel units comprises a common electrode portion, a first insulating layer, a first pixel electrode portion, a first passivation layer, and a second pixel electrode portion which are sequentially arranged in a stacked manner on the substrate;
the first passivation layer comprises at least one via, and the second pixel electrode portion is electrically connected to the first pixel electrode portion through the at least one via;
a thickness of the first insulating layer is smaller than a thickness of the first passivation layer; and
the common electrode portion and the first pixel electrode portion form a first storage capacitor, the common electrode portion and the second pixel electrode portion form a second storage capacitor, and orthogonal projections of the common electrode portion, the first pixel electrode portion, and the second pixel electrode portion on the substrate each cover an orthogonal projection of the at least one via on the substrate.

2. The electronic paper display panel according to claim 1, wherein in each of the plurality of pixel units, the first passivation layer comprises a plurality of vias of the at least one via, and the orthogonal projections of the common electrode portion, the first pixel electrode portion, and the second pixel electrode portion on the substrate each cover the orthogonal projection of the plurality of vias on the substrate.

3. The electronic paper display panel according to claim 2, wherein in each of the plurality of pixel units, connection lines connecting the plurality of vias enclose and form a polygonal area, and the orthogonal projections of the common electrode portion, the first pixel electrode portion, and the second pixel electrode portion on the substrate each cover an orthogonal projection of the polygonal area on the substrate.

4. The electronic paper display panel according to claim 1, wherein the orthogonal projection of the common electrode portion on the substrate covers the orthogonal projection of the first pixel electrode portion on the substrate.

5. The electronic paper display panel according to claim 4, wherein an area of the orthogonal projection of the common electrode portion on the substrate is equal to an area of the orthogonal projection of the first pixel electrode portion on the substrate and an area of the orthogonal projection of the second pixel electrode portion on the substrate separately.

6. The electronic paper display panel according to claim 1, further comprising a plurality of scan lines and a plurality of data lines;
wherein the plurality of scan lines intersect the plurality of data lines to form a plurality of opening zones, and the plurality of pixel units are disposed within the plurality of opening zones, respectively; and
the plurality of scan lines are disposed in a same layer with the common electrode portion in each pixel unit, and the plurality of data lines are disposed in a same layer with the first pixel electrode portion in each pixel unit.

7. The electronic paper display panel according to claim 6, further comprising a common electrode connecting portion;
wherein in an extension direction of the plurality of scan lines, common electrode portions in two adjacent pixel units among the plurality of pixel units are electrically connected through the common electrode connecting portion.

8. The electronic paper display panel according to claim 6, wherein in each of the plurality of pixel units, a minimum distance between a scan line, corresponding to the pixel unit, of the plurality of scan lines and the common electrode portion in the pixel unit is a first distance;
wherein the electronic paper display panel further comprises a plurality of thin-film transistor groups, and the plurality of thin-film transistor groups are in one-to-one correspondence with the plurality of pixel units; and
each of the plurality of thin-film transistor groups comprises two gates sequentially arranged in an extension direction of the plurality of scan lines, and the two gates are disposed in the same layer with the plurality of scan lines; and
wherein a distance between the two adjacent gates in each thin-film transistor group is a second distance, and the second distance is smaller than or equal to the first distance.

9. The electronic paper display panel according to claim 8, wherein a minimum distance between an edge of the two gates and the common electrode portion corresponding to the thin-film transistor group is a third distance, and the third distance is smaller than or equal to the first distance.

10. A display device, comprising:
a housing and an electronic paper display panel;
wherein the housing has an accommodating space, the electronic paper display panel is disposed in the housing, and a display medium of the electronic paper display panel is electrophoretic particles;
wherein the electronic paper display panel, comprising:
a substrate and a plurality of pixel units disposed on the substrate;
wherein each of the plurality of pixel units comprises a common electrode portion, a first insulating layer, a first pixel electrode portion, a first passivation layer, and a second pixel electrode portion which are sequentially arranged in a stacked manner on the substrate;
the first passivation layer comprises at least one via, and the second pixel electrode portion is electrically connected to the first pixel electrode portion through the at least one via;
a thickness of the first insulating layer is smaller than a thickness of the first passivation layer; and
the common electrode portion and the first pixel electrode portion form a first storage capacitor, the common electrode portion and the second pixel electrode portion form a second storage capacitor, and orthogonal projections of the common electrode portion, the first pixel electrode portion, and the second pixel electrode portion on the substrate each cover an orthogonal projection of the at least one via on the substrate.

11. The display device according to claim 10, wherein in each of the plurality of pixel units, the first passivation layer comprises a plurality of vias of the at least one via, and the orthogonal projections of the common electrode portion, the first pixel electrode portion, and the second pixel electrode portion on the substrate each cover the orthogonal projection of the plurality of vias on the substrate.

12. The display device according to claim 11, wherein in each of the plurality of pixel units, connection lines connecting the plurality of vias enclose and form a polygonal area, and the orthogonal projections of the common electrode portion, the first pixel electrode portion, and the second pixel electrode portion on the substrate each cover an orthogonal projection of the polygonal area on the substrate.

13. The display device according to claim 10, wherein the orthogonal projection of the common electrode portion on the substrate covers the orthogonal projection of the first pixel electrode portion on the substrate.

14. The display device according to claim 13, wherein an area of the orthogonal projection of the common electrode portion on the substrate is equal to an area of the orthogonal projection of the first pixel electrode portion on the substrate and an area of the orthogonal projection of the second pixel electrode portion on the substrate separately.

15. The display device according to claim 10, further comprising a plurality of scan lines and a plurality of data lines;
wherein the plurality of scan lines intersect the plurality of data lines to form a plurality of opening zones, and the plurality of pixel units are disposed within the plurality of opening zones, respectively; and
the plurality of scan lines are disposed in a same layer with the common electrode portion in each pixel unit, and the plurality of data lines are disposed in a same layer with the first pixel electrode portion in each pixel unit.

16. The display device according to claim 15, further comprising a common electrode connecting portion;
wherein in an extension direction of the plurality of scan lines, common electrode portions in two adjacent pixel units among the plurality of pixel units are electrically connected through the common electrode connecting portion.

17. The display device according to claim 15, wherein in each of the plurality of pixel units, a minimum distance between a scan line, corresponding to the pixel unit, of the plurality of scan lines and the common electrode portion in the pixel unit is a first distance;
wherein the electronic paper display panel further comprises a plurality of thin-film transistor groups, and the plurality of thin-film transistor groups are in one-to-one correspondence with the plurality of pixel units; and
each of the plurality of thin-film transistor groups comprises two gates sequentially arranged in an extension direction of the plurality of scan lines, and the two gates are disposed in the same layer with the plurality of scan lines; and
wherein a distance between the two adjacent gates in each thin-film transistor group is a second distance, and the second distance is smaller than or equal to the first distance.

18. The display device according to claim 17, wherein a minimum distance between an edge of the two gates and the common electrode portion corresponding to the thin-film transistor group is a third distance, and the third distance is smaller than or equal to the first distance.
